(19) United States
(12) Patent Application Publication
(10) Pub. No.: US 2011/0120943 A1
(43) Pub. Date: May 26, 2011

(54) BIOCOMPATIBLE FILTER MEMBER FOR BODY FLUID DIALYSIS AND FABRICATION AND USE THEREOF

(75) Inventors: Anders Johansson, Uppsala (SE); Marten Rooth, Uppsala (SE); Mats Boman, Jarlasa (SE); Anders Harsta, Balinge (SE); Jan-Otto Carlsson, Uppsala (SE); Lars-Ake Brodin, Taby (SE)

(73) Assignee: NANEXA AB, Uppsala (SE)

(21) Appl. No.: 12/812,630

(22) PCT Filed: Dec. 4, 2008
(86) PCT No.: PCT/SE2008/051405

§ 371 Date: Nov. 10, 2010

(30) Foreign Application Priority Data
Jan. 14, 2008 (SE) 0800073-9

(51) Int. Cl. B01D 39/14; B05D 5/00; C25D 5/48

(52) U.S. Cl. 210/506; 427/244; 205/220

(57) ABSTRACT

A biocompatible filter member for body fluid dialysis is provided. The filter membrane comprises a porous substrate comprising a metal oxide, and the filter member has all exposed surfaces provided with a biocompatible coating. A method of making the biocompatible filter member is further provided.

### FIELD OF THE INVENTION AND PRIOR ART

The present invention relates to a biocompatible filter member for body fluid dialysis.

The term “biocompatible” refers to the ability of the device to carry out its intended function within flowing blood, with minimal interaction between device and blood that adversely affects device performance, and without inducing uncontrolled activation of cellular or plasma protein cascades.

In this description and the subsequent claims, the expression “macroscopic surface” is used for the surface which can be seen, thus excluding the inside surface of the pores, and the expression “microscopic surface” is used for the macroscopic surface with the inside surface of the pores included.

In this description and the subsequent claims, the expression “biocompatible coating” is used for a biocompatible part of a filter surface which can comprise parts of a substrate and/or a layer deposited onto a filter member's microscopic surface.

Filter members of this type are used in connection with dialysis and are often of the disposable kind. Nowadays, such filter members are normally composed by a bundle of hollow tubes allowing for a fluid to be dialysed, e.g. blood, to pass through the tubes in one direction, while a dialysis liquid passes outside the tubes in the opposite direction. A lamellar filter construction was more common earlier, but is still used to some extent. In both types of dialysis filters, a filtrate are allowed to pass through the pores, this way removing unwanted salts and/or, from the body, residual products, from the fluid to be dialysed, e.g. blood, to the dialysis liquid.

The hollow tubes used for most of the filter embodiments for dialysis usually comprise a cellulosic polymer which is formed with pores penetrating the tube walls. The commercially available filters have specified nominal pore sizes, but usually there are size discrepancies when comparing the pores with each other.

A well known problem is that patients often contract an inflammation during dialysis. This is due to an immunological response by the immune system present in the body fluid. Thus the filter materials, or more specific, the microscopic surfaces of the filter materials exposed to the body fluid, have to be biocompatible—in other words especially compatible with blood. The complement activation should be as low as possible and the filter material should not exhibit any thrombogenesis. The filter material should also be resistant to ageing.

### OBJECT OF THE INVENTION

The object of the present invention is to provide a biocompatible filter member for dialysis of body fluids which is improved in at least some aspect with respect to such filter members already known.

### SUMMARY OF THE INVENTION

According to the present invention, said object is achieved by providing a filter member having the features defined in claim 1.

By the fact that the filter member comprises a porous substrate comprising a metal oxide, and that filter member has all exposed surfaces provided with a biocompatible coating, an improved inhibition of said complement activation compared to filter members already known is obtained. Filtration can be performed more selectively compared to the prior art by providing the well-defined porosity of said filter member.

According to an embodiment of the invention the metal oxide of the substrate comprises an anodic metal oxide. Anodization is a method which enables large scale production of porous materials by using fairly cheap means. The metal oxides produced by anodization are generally chemically inert and the porosity is usually tuneable by choosing appropriate anodization parameters.

According to another embodiment of the invention, said anodic oxide is anodic aluminium oxide. Aluminium is the most common metal for anodization. The reasons for this are many. First of all is aluminium a fairly cheap metal which can be purchased in many forms, including foils and sheets etc. Secondly aluminium with all kinds of geometries and shapes can readily be anodized, and the porosity, the pore diameters, the inter-pore distance as well as the thickness of the porous substrate can readily be tuned.

According to another embodiment of the invention the filter member is on at least one of its sides provided with a stabilizing structure, such as a grid or mesh of a polymeric material. The stabilizing structure is provided to enhance the structural strength of the filter member. Since the main part of the filter member comprises a relatively brittle metal oxide a polymeric grid-like structure can enhance the structural strength of the filter member. The stabilizing structure can for instance be a mesh of polymeric fibres, spun on at least one side of the filter member.

According to another embodiment of the invention, said filter member has a thickness ranging between 5-100, 10-60, 20-50, 5-30 or 50-100 μm. If a high pressure is applied during an operation a relatively thick filter member is necessary to withstand crack formation. If the pressure is lower a thinner filter member can be used to instead optimize the diffusion distance through the pores.

According to another embodiment of the invention, said filter member has a porosity ranging between 10⁶-10¹², 10⁸-10¹¹, 10¹⁰-10¹¹ or 10¹¹-10¹² pores/cm². Dialysis is a therapy form which can not be performed at a speed which is too high, e.g. due to the fact that a too rapid change in salt concentration in the blood causes a physiological trauma in the patient. By tuning the porosity, the dialysis speed can be regulated and said trauma can be avoided.

According to another embodiment of the invention, the pores of said filter member have diameters ranging between 5-1000, 15-500, 25-150 or 30-100 nm. By tuning the diameters of the pores the filtering properties can be chosen. Small pores allows for small molecules to pass, while blocking larger molecules. If it is desirable to allow for larger molecules to pass the filter member, larger pore diameters are chosen in accordance.

According to another embodiment of the invention, said filter member has inter-pore distances ranging between 25-1000, 30-500, 50-250 or 80-120 nm. The inter-pore distances affect the pore diameters as well as the porosity of said filter member.

According to another embodiment of the invention, said biocompatible coating has a thickness ranging between 0.1-50, 1-30, 5-20 or 10-20 nm. The thickness of the coating is chosen depending to the crystallinity of the coating. It is important that the coating completely covers the underlying substrate, i.e. the coating is homogenous. If the metal oxide coating is crystalline it has to be relatively thick to avoid pin holes. If instead the metal oxide coating is amorphous it can be thinner and still avoid pin holes. The coating can also serve as a fine tuning of the pore diameters.

According to another embodiment of the invention, the biocompatible coating consists of a metal oxide. Metal oxides are usually chemically inert and can readily be protected against aging, e.g. by forcing an aging by physical treatments such as heat treatment. Many metal oxides are also known to be biocompatible.

According to another embodiment of the invention, the biocompatible metal oxide coating consists of titanium oxide. Titanium oxide is well known to be biocompatible and is already commonly used in various medical applications, e.g. on the surfaces of hip prostheses.

According to another embodiment of the invention, said coating is formed by surface portions of said substrate, e.g. by physical or chemical treatments such as heat treatments, treatment with surfactants e.g. coating with heparin for reduction of blood-coagulation on the surfaces etc. By this a reduction in process time, consequently a reduction of production cost, can be achieved.

According to another embodiment of the invention, said coating is formed by a layer applied outside said substrate, by means of e.g. deposition. Since a multitude of deposition techniques for all kinds of materials are available, mechanical, medical and physiological properties of the coating material can be chosen by selection of a suitable deposition technique and coating material.

According to another embodiment of the invention, the method for anodizing the aluminium to anodic aluminium oxide comprises anodization in an electrolyte of sulphuric, chromic, phosphoric or oxalic acid. Depending on the anodization voltage, different electrolytes have to be chosen.

According to another embodiment of the invention, the method for anodizing the aluminium to anodic aluminium oxide comprises anodization under voltages ranging between 5-500, 20-200, 25-150 or 30-60 V. The chosen voltage affects the inter-pore distance, which in turn affects the pore diameters and the porosity.

According to another embodiment of the invention, the method for providing said coating is by deposition. Various kinds of deposition techniques are known to provide for material coatings, e.g. sol-gel techniques, wet-chemical techniques, physical vapour deposition (PVD), chemical vapour deposition (CVD), atomic layer deposition (ALD) etc. Different deposition techniques offer different advantages, e.g. wet-chemical techniques are usually cheaper than for instance PVD, since PVD requires expensive equipment. On the other hand might PVD offer coating characteristics which are hard to achieve through wet-chemical techniques.

According to another embodiment of the invention, the method for providing said coating is by atomic layer deposition (ALD). ALD is one of the only deposition techniques which offer homogenous deposition on high aspect-ratio nanostructures.

According to another embodiment of the invention, the precursors used for deposition by means of ALD are one titanium containing precursor, e.g. TiCl₄, TiI₄, Ti(OMe)₄, Ti(OEt)₄, Ti(OiPr)₄, Ti(OiPr)₂(dmae)₂, Ti(OBu)₄ or Ti(NMe₂)₄, and one oxygen containing precursor, e.g. H₂O, O₂, H₂O₂ or O₃. There are numerous reports of precursor combinations for fabrication of titanium oxide using ALD. A suitable precursor combination is chosen depending on the desired result and the design of the ALD apparatus.

According to another embodiment of the invention, the precursors used for the depositions by means of ALD are TiI₄ and H₂O. The chosen precursor combination results in very low (<1 atomic percent) contamination from by-products during the deposition. It also produces highly homogenous coatings.

According to another embodiment of the invention, said filter member is used for body fluid dialysis operating with standard equipment, or in an equipment specially made for the above mentioned filter member, e.g. in home dialysis apparatuses.

Other advantages and advantageous features of the invention will appear from the other dependent claims and the subsequent description.

### BRIEF DESCRIPTION OF THE DRAWINGS

The invention will in the following be more closely described with reference to the appended drawings showing embodiments of the invention cited as examples. It is shown in:

FIG. 1 a perspective view of a biocompatible filter member, and

FIG. 2 a cross-sectional view of a filter member comprising a porous substrate comprising a metal oxide with all exposed surfaces provided with a biocompatible coating.

### DETAILED DESCRIPTION OF PREFERRED EMBODIMENTS

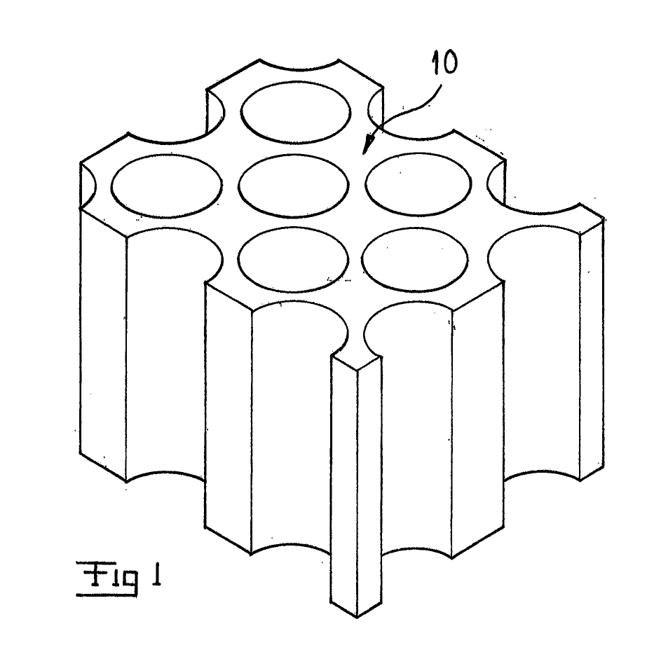

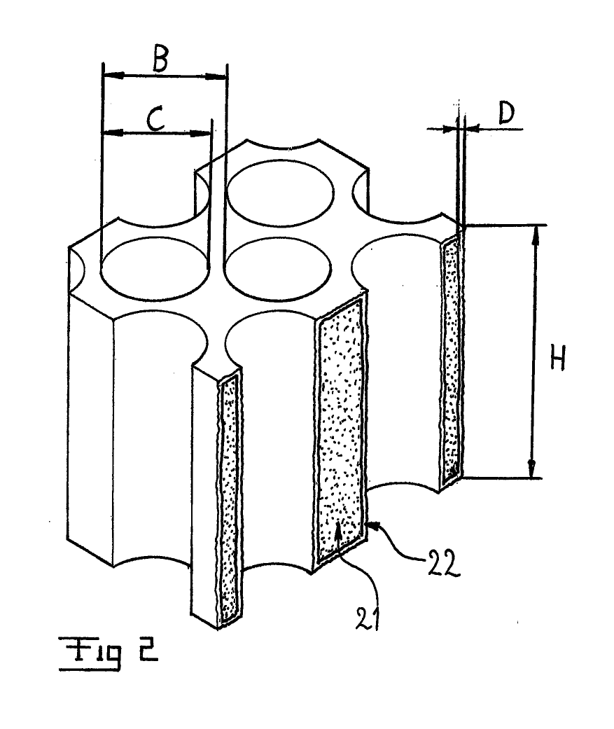

FIGS. 1 and 2 illustrate embodiments of a filter member 10 for body fluid dialysis according to the present invention. The filter member 10 comprises a porous substrate 21 comprising a metal oxide, preferably an anodic metal oxide, more preferably anodic aluminium oxide, and said filter member 10 has all exposed surfaces provided with a biocompatible coating 22, with the coating 22 preferably consisting of a metal oxide, more preferably titanium oxide.

The filter member 10 has a thickness H ranging between 5-100, 10-60, 20-50, 5-30 or 50-100 μm and a porosity ranging between 10⁸-10¹², 10⁸-10¹¹, 10¹⁰-10¹¹ or 10¹¹-10¹² pores/cm2. The pores of the filter member have diameters C ranging between 5-1000, 15-500, 25-150 or 30-100 nm and inter-pore distances B ranging between 25-1000, 30-500, 50-250 or 80-120 nm. The biocompatible coating 22 has a thickness D ranging between 0.1-50, 1-30, 5-20 or 10-20 nm.

Anodization of aluminium can be performed as follows: Optionally one surface of aluminium foils is processed until a very low roughness (<5 nm) is obtained; this can e.g. be performed by electropolishing in an ethanol (99.5%)/perchloric acid (60%) solution (4:1 by volume) under a constant voltage of 20 V for about 3-5 minutes. The anodization of aluminium is performed in an electrolyte of sulphuric, chromic, phosphoric or oxalic acid, with the aluminium foil anodically connected to an electrochemical cell. The temperature of the electrolyte is preferably held at 1-30° C., and depending on the desired inter-pore distance B and pore diameters C a constant anodization voltage between 5-500, 20-200, 25-150 or 30-60 V is chosen, e.g. 40 V results in an inter-pore distance B of 100 nm and 196 V results in an inter-pore distance B of 500 nm. The anodization is performed for 1-3000 minutes, the longer the anodization is performed, the larger will the thickness H of the aluminium oxide substrate be, e.g. under some specific conditions the thickness of the substrate will increase by 2 μm/60 minutes. After anodization the pore diameters C will be about ¼ of the inter-pore distance B. By subsequent etching in an acid or base which dissolves the aluminium oxide substrate, e.g. phosphoric acid, the pore diameters C can be increased, of course the pore diameters C can never exceed the inter-pore distance B.

A coating of a metal oxide 22 is provided to all exposed surfaces of said filter member 10. This can for instance be performed by deposition of titanium oxide by means of atomic layer deposition (ALD), using a standard or a custom built ALD apparatus. For ALD of titanium oxide, one titanium containing precursor, e.g. TiCl₄, TiI₄, Ti(OMe)₄, Ti(OEt)₄, Ti(OiPr)₄, Ti(OiPr)₂(dmae)₂, Ti(OBu)₄ or Ti(NMe₂)₄, and one oxygen containing precursor, e.g. H₂O, O₂, H₂O₂ or O₃, have to be used. During ALD the substrate is placed in a deposition chamber, which is heated to a desired temperature (50-700° C.); the temperature is chosen according to the desired crystalline phase of the deposited metal oxide. Precursors are injected to the deposition chamber in gas pulses, i.e. if the precursor is a solid or a liquid it has to be evaporated in a preceding step. The pulses are separated from each other by a purging pulse of an inert gas, such as argon or nitrogen. For instance when depositing titanium oxide using TiI₄ and H₂O as precursors, a first pulse of gaseous TiI₄ is injected to the deposition chamber and saturates the substrate's microscopic surface. A purging pulse of argon and nitrogen follows to remove excess of TiI₄ as well as ligands, decoupled from the precursor during adsorption. Gaseous water is injected and by a ligand exchange the water is reacting with the titanium containing precursor adsorbed to the surface to form one or more molecular layer of titanium oxide. By-products, e.g. HI, and/or water excess are purged with a second pulse of an inert gas, e.g. argon or nitrogen. Each pulse must have duration sufficient to completely adsorb, purge and/or react to/on the whole microscopic surface, the duration is dependent on the design of the ALD reactor. Said pulse scheme is repeated until the desired thickness D of the metal oxide is achieved, preferably between 0.1-50 nm.

The inventive filter member 10 is intended to be used in connection with dialysis of body fluids, e.g. kidney dialysis, liver dialysis, separation of proteins etc., in dialysis apparatuses including standard equipment for hospitals as well as dialysis equipment for use in the patients' home.

It is understood that said porous metal oxide substrate 21 can be achieved by other methods, such as ion beam lithography, conventional lithography, sol-gel synthesis etc. Also anodization can be performed by using titanium instead of aluminium, thereby producing a substrate 21 comprising titanium oxide. For a person skilled in the art it is also natural that other precursors and precursor combinations as well as other deposition techniques can be used to obtain said metal oxide coating 22 on the microscopic surface of the porous metal oxide substrate 21.

The invention is of course not in any way limited to the embodiments described above. On the contrary, several possibilities to modifications thereof should be apparent to a person skilled in the art without departing from the basic idea of the invention as defined in the appended claims.

1-28. (canceled)

29. A biocompatible filter member for body fluid dialysis, wherein the biocompatible filter member comprises a porous substrate comprising a metal oxide, and that the biocompatible filter member has all exposed surfaces provided with a biocompatible coating.

30. The biocompatible filter member according to claim 29, wherein the metal oxide of the substrate comprises an anodic metal oxide.

31. The biocompatible filter member according to claim 30, wherein the anodic metal oxide is anodic aluminium oxide.

32. The biocompatible filter member according to claim 29, wherein the biocompatible filter member on at least one of its sides is provided with a stabilizing structure, such as a grid or mesh of a polymeric material.

33. The biocompatible filter member according to claim 29, wherein the biocompatible filter member has a thickness ranging between 5-100, 10-60, 20-50, 5-30 or 50-100 μm.

34. The biocompatible filter member according to claim 29, wherein the biocompatible filter member has a porosity ranging between 10⁶-10¹², 10⁸-10¹¹, 10¹⁰-10¹¹ or 10¹¹-10¹² pores/cm2.

35. The biocompatible filter member according to claim 33, wherein the biocompatible filter member comprises pores having diameters ranging between 5-1000, 15-500, 25-150 or 30-100 nm.

36. The biocompatible filter member according to claim 34, wherein the biocompatible filter member has inter-pore distances ranging between 25-1000, 30-500, 50-250 or 80-120 nm.

37. The biocompatible filter member according to claim 29, wherein the biocompatible coating has a thickness ranging between 0.1-50, 1-30, 5-20 or 10-20 nm.

38. The biocompatible filter member according to claim 29, wherein the biocompatible coating consists of a metal oxide.

39. The biocompatible filter member according to claim 38, wherein the biocompatible coating consists of titanium oxide.

40. The biocompatible filter member according to claim 29, wherein the biocompatible coating is formed by surface portions of said substrate.

41. The biocompatible filter member according to claim 29, wherein the biocompatible coating is formed by a layer applied outside the porous substrate.

42. A method for fabrication of a biocompatible filter member, comprising manufacturing a permeable metal oxide substrate; and providing the exposed surfaces of the permeable metal oxide substrate with a biocompatible coating.

43. The method according to claim 42, wherein the permeable metal oxide substrate is manufactured by anodization of a metal.

44. The method according to claim 43, wherein the metal subjected to anodization is aluminum.

45. The method according to claim 44, wherein the anodization of aluminium is performed in an electrolyte of sulphuric, chromic, phosphoric or oxalic acid.

46. The method according to claim 43, wherein the anodization is performed under anodization voltages ranging between 5-500, 20-200, 25-150 or 30-60 V.

47. The method according to claim 42, wherein the exposed surfaces of the porous metal oxide substrate are provided with the biocompatible coating by means of deposition.

48. The method according to claim 47, wherein the deposited biocompatible coating material is a metal oxide.

49. The method according to claim 48, wherein the material of the biocompatible metal oxide coating is titanium oxide.

50. The method according to claim 42, wherein the exposed surfaces of the porous metal oxide substrate are provided with the biocompatible coating by means of atomic layer deposition.

51. The method according to claim 50, wherein precursors used for the atomic layer deposition are a titanium containing precursor and an oxygen containing precursor.

52. The method according to claim 51, wherein the titanium containing precursor used for the atomic layer deposition is titanium iodide.

53. The method according to claim 51, wherein the oxygen containing precursor used for the atomic layer deposition is water.

54. The method according to claim 42, wherein the biocompatible coating is deposited until a film thickness of 0.1-50, 1-30, 5-20 or 10-20 nm is achieved.

55. The method according to claim 42, wherein the biocompatible coating is achieved by treatment of surface portions of the permeable metal oxide substrate.

56. Body fluid dialysis equipment comprising the biocompatible filter membrane according to claim 29.
